(19) United States
(12) Patent Application Publication
(10) Pub. No.: US 2014/0372158 A1
(43) Pub. Date: Dec. 18, 2014

(54) Determining Optimal Decision Trees

(71) Applicant: FAIR ISAAC CORPORATION, San Jose, CA (US)

(72) Inventors: Brendan Del Favero, Davis, CA (US); Rhonda Alexander, Austin, TX (US); David Berlin, San Diego, CA (US); Ichiro Kubota, San Diego, CA (US); Mary Krone, San Rafael, CA (US); Jean Zoch, Albany, CA (US)

(21) Appl. No.: 14/298,143

(22) Filed: Jun. 6, 2014

Related U.S. Application Data
(60) Provisional application No. 61/834,283, filed on Jun. 12, 2013.

(51) Int. Cl. G06Q 10/06; G06N 5/04; G06Q 30/02

(52) U.S. Cl. CPC G06Q 10/063; G06Q 30/0251; G06Q 40/025; G06N 5/04
USPC 705/7.11

(57) ABSTRACT

The current subject matter relates to generation, modification, export, and/or import of decision trees, based on which optimal treatments (for example, offers) can be assigned to various records (for example, customers). A tree-generating application can receive constraints characterizing specifications for a decision tree desired by the user of the tree-generating application. The tree-generating application can generate a mathematical equation based on the constraints. The tree-generating application can receive, from a first database, historical data characterizing treatments provided to a plurality of representative customers having corresponding attributes. The tree-generating application can execute a simplex method of linear programming to search for the decision tree desired by the user from a plurality of decision trees stored in a second database stored in a second database. The tree-generating application can send the decision tree to a tree-using application. The tree-using application can use the decision tree to determine a treatment for a customer.

### RELATED APPLICATION

This patent application claims priority to U.S. Provisional Patent Application Ser. No. 61/834,283, entitled “Generating Optimal Decision Trees,” and filed on Jun. 12, 2013, the contents of which are herein incorporated by reference in entirety.

### TECHNICAL FIELD

The subject matter described herein relates to: a first software application that searches for a most optimal decision tree from a plurality of stored decision trees, modifies the most optimal decision tree, exports the most optimal decision tree, and/or imports the most optimal decision tree; and a second software application that uses the most optimal decision tree to assign optimal treatments (for example, offers) to various records (for example, customers).

### BACKGROUND

Assignment of treatments (for example, offers) to multiple records (for example, customers) is well known. Typically, the treatments are required to be assigned to the records based on multiple granularity, eligibility, and consistency constraints that may be dictated by various business rules. To assign treatments to records, an analyst conventionally manually finds a particular decision tree from numerous available decision trees that he/she considers optimal for the process of assignment. However, because the multiple granularity, eligibility, and consistency constraints can be large in number, the use of the selected decision tree often necessitates assignment to be in disaccord with at least some of those constraints.

### SUMMARY

The current subject matter describes: a first software application that searches for a most optimal decision tree from a plurality of stored decision trees, modifies the most optimal decision tree, exports the most optimal decision tree, and/or imports the most optimal decision tree; and a second software application that uses the most optimal decision tree to assign optimal treatments (for example, offers) to various records (for example, customers). The first software application can be referred to as a tree-generating application, which can receive constraints characterizing specifications for a decision tree desired by the user of the tree-generating application. The tree-generating application can generate a mathematical equation based on the constraints. The tree-generating application can receive, from a first database, historical data characterizing treatments provided to a plurality of representative customers having corresponding attributes. The tree-generating application can execute a simplex method of linear programming to search for the decision tree desired by the user from a plurality of decision trees stored in a second database stored in a second database. The tree-generating application can send the decision tree to the second software application, which can also be referred to as a tree-using application. The tree-using application can use the decision tree to determine a treatment for a customer. Related methods, systems, apparatuses, non-transitory computer program products, and devices are also described.

In one aspect, a tree-generating application executed by at least one data processor can receive one or more constraints characterizing specifications for a decision tree. The tree-generating application can generate a mathematical equation based on the one or more constraints. The tree-generating application can receive, from a first database connected to the at least one processor, historical data characterizing treatments provided to a plurality of representative customers having corresponding attributes. The tree-generating application can execute a simplex method of linear programming using the mathematical equation and the historical data to search for the decision tree from a plurality of decision trees stored in a second database connected to the at least one processor. The tree-generating application can send the decision tree to a tree-using application executed by a second data processor. The tree-using application can use the decision tree to determine a treatment for a customer.

In some variations, one or more of the following can be implemented either individually or in any suitable combination. In one implementation, the first data processor can be same as the second data processor. In another implementation, the first data processor can be different from the second data processor. The tree-using application can be operated by an authorized user at a retail entity. In one example, the customer can be a shopper at the retailer entity. The treatment of this customer can specify an offer provided to the shopper by the retail entity. The offer can be a discount offer on a product provided by the retail entity. The tree-using application can be operated by an authorized user at a financial institution. In another example, the customer can be an individual seeking a loan from the financial institution. The treatment of the customer can specify whether the financial institution should approve the loan to the individual. The attributes of a representative customer of the plurality of representative customers can include a credit bureau score of the representative customer, an initial credit limit of the representative customer, and an application score of the representative customer.

The decision tree can include a flow chart including a start node, a plurality of intermediate nodes, and a plurality of terminal nodes, the flow chart representing a plurality of classification rules between the start node and the terminal node that are based on the attributes of the plurality of representative customers. The plurality of classification rules can be used to map each representative customer with a corresponding terminal node of the plurality of terminal nodes. Each terminal node can characterize a corresponding treatment. The specifications can include granularity constraints, eligibility constraints, and consistency constraints. The granularity constraints specify decision keys and split thresholds for nodes of the decision tree. The eligibility constraints can specify eligible treatments for a representative customer based on the decision keys. The consistency constraints can specify patterns for assignment of treatments to terminal nodes of the decision tree.

The tree-generating application can prune the decision tree by removing redundant nodes and branches of the decision tree when the tree-generating application receives a user preference for the decision tree to be simplified.

In another aspect, at least one data processor can receive one or more constraints characterizing specifications for a decision tree. The at least one data processor can generate a mathematical equation based on the one or more constraints. The at least one data processor can receive, from a first database connected to the at least one processor, historical data characterizing treatments provided to a plurality of representative customers having corresponding attributes. The at least one data processor can execute a simplex method of linear programming using the mathematical equation and the historical data to search for the decision tree from a plurality of decision trees stored in a second database connected to the at least one processor. The decision tree can be used to determine a treatment for a customer.

In some variations, one or more of the following can be implemented either individually or in any suitable combination. The decision tree can be used by a second data processor to determine the treatment. The second data processor can be same as the first data processor. The first data processor can be separate from the second data processor. The first data processor can be connected to the second data processor via a communication network.

In yet another aspect, a system is described that can include a first computer and a second computer. The first computer can execute a tree-generating application. The tree-generating application can receive one or more constraints characterizing specifications for a decision tree. The tree-generating application can generate a mathematical equation based on the one or more constraints. The tree-generating application can receive historical data characterizing treatments provided to a plurality of representative customers having corresponding attributes from a first database connected to the first computer. The tree-generating application can execute a simplex method of linear programming using the mathematical equation and the historical data to search for the decision tree from a plurality of decision trees stored in a second database connected to the at least one processor. The second computer can execute a tree-using application. The tree-using application can receive the decision tree. The tree-using application can use the decision tree to determine a treatment for a customer.

In some variations, one or more of the following can be implemented either individually or in any suitable combination. In one example, the first computer can be same as the second computer. In another example, the first computer can be separate from the second computer, wherein the first computer can be connected to the second computer via a communication network.

Computer program products are also described that include non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the software application can obtain decision trees customized based on multiple granularity, eligibility, and consistency constraints that may be dictated by various business rules. More specifically, the obtained decision trees can assign treatments (for example, offers) to records (for example, customers) in accordance with and without violating any constraints.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a computing system for searching (to determine or obtain), modifying, exporting, importing, and/or using a decision tree;

FIG. 2 is a system diagram illustrating an alternate computing system for searching (to determine or obtain), modifying, exporting, importing, and/or using a decision tree;

FIG. 3 is a diagram illustrating one example of a decision tree;

FIG. 4 is a diagram illustrating a system for determining and using a decision tree;

FIG. 5 is a flow diagram illustrating determining of a decision tree by a tree-generating application and the sending of this decision tree to a tree-using application;

FIG. 6 is a flow diagram illustrating use of a decision tree by a tree-using application to determine a treatment recommended for a customer;

FIG. 7 is a diagram illustrating a graphical user interface executed by the tree-generating application to receive data associated with a design of a decision tree that is to be searched from a large number of stored decision trees;

FIG. 8 is a diagram illustrating a portion of a graphical user interface that allows a user to configure account inputs, handle special data, and perform aggregation control from a large number of stored decision trees;

FIG. 9 is a diagram illustrating a graphical user interface that allows the user to specify granularity constraints, eligibility constraints, consistency constraints, number of decision keys, and number of nodes for the decision tree that is to be searched from a large number of stored decision trees;

FIG. 10 is a diagram illustrating a graphical user interface executed by the tree-generating application to display and specify granularity constraints of the decision tree that is to be searched from a large number of stored decision trees;

FIG. 11 is a diagram illustrating a graphical user interface executed by the tree-generating application to display and specify granularity constraints associated with the decision tree template when a base tree is selected;

FIG. 12 is a diagram illustrating a graphical user interface executed by the tree-generating application to display and specify eligibility constraints for the decision tree that is to be searched from a large number of stored decision trees;

FIG. 13 is a diagram illustrating a graphical user interface executed by the tree-generating application to display and specify consistency constraints for the decision tree that is to be searched from a large number of stored decision trees;

FIG. 14 is a diagram illustrating a graphical user interface that displays the list of decision trees that have already been created by the tree-generating application;

FIG. 15 is a diagram illustrating a graphical user interface that displays pop-up window to allow the user to view or modify properties of an existing decision tree shown in the display area;

FIG. 16 is a diagram illustrating a graphical user interface illustrating design scenarios;

FIGS. 17A, 17B, and 17C are diagrams illustrating read-only summary results of optimization performed to search a decision tree from a large number of stored decision trees;

FIG. 18 is a diagram illustrating another example of summary results of optimization performed to search a decision tree from a large number of stored decision trees;

FIG. 19 is a diagram illustrating advanced simulation settings for searching a decision tree from a large number of stored decision trees;

FIG. 20 is a diagram illustrating a graphical user interface displaying properties of the project being performed to search a decision tree from a large number of stored decision trees;

FIG. 21 is a diagram illustrating a graphical user interface that allows a user to compare performance of a searched decision tree 302 with existing decision trees shown in the display area;

FIG. 22 is a diagram illustrating a segmentation editor that allows a user to specify data associated with bins and segments that can be used during search of the decision tree; and

FIG. 23 is a diagram illustrating a graphical user interface executed by the tree-generating application to export optimization results to an external decision tree editing application.

Like reference symbols in the various drawings indicate like elements.

### DETAILED DESCRIPTION

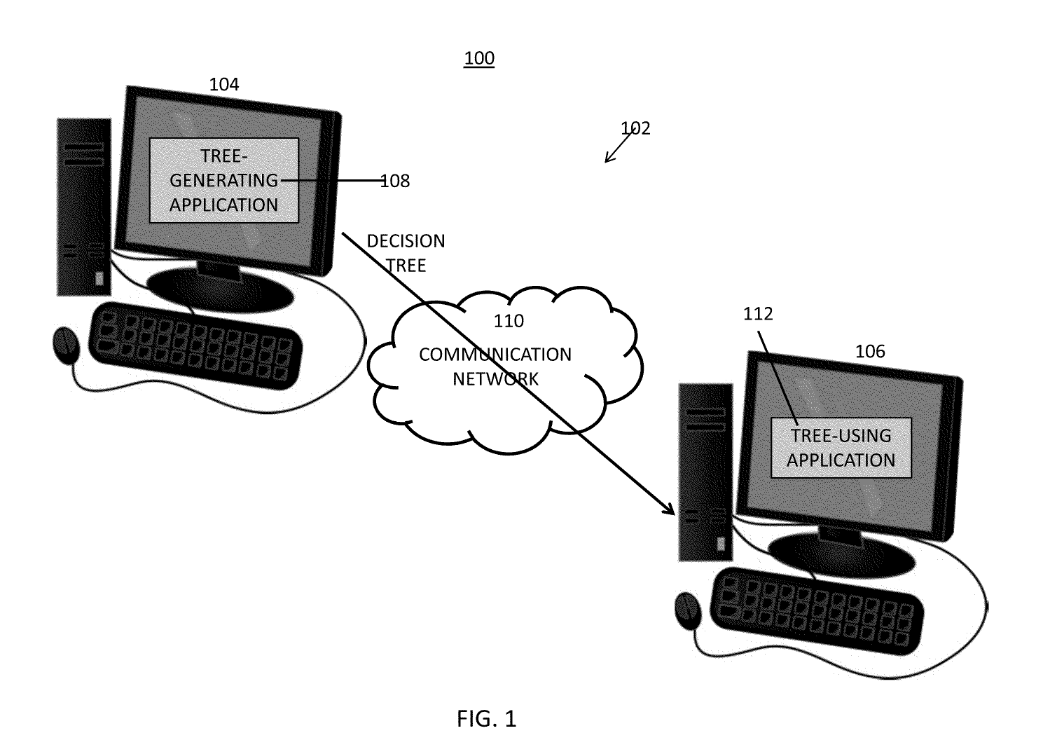

FIG. 1 is a system diagram 100 illustrating a computing system 102 for searching (to determine or obtain), modifying, exporting, importing, and/or using a decision tree. One example of a decision tree is described below by diagram 300. The computing system 102 can include a client-server architecture that can include a server computer 104 and a client computer 106. The server computer 104 can execute a tree-generating application 108 that can find a most optimal decision tree from a large number of decision trees based on constraints specified by an authorized user of the server computer 104. The server computer 104 can send/export the decision tree to the client computer 106 via a communication network 110. The client computer 106 can execute a tree-using application 112 that can receive/import the decision tree and use the decision tree to assign optimal treatments (for example, offers) to multiple records (for example, customers).

The server computer 104 can be one or more of: a laptop computer, a desktop computer, a tablet computer, a smart phone, a phablet, and any other computing device. In an alternate implementation, the server computer 104 can be a distributed computing system, which can include a cluster of computing devices. The server computer 104 can be operated by an authorized user, which can also be referred to as a system administrator, a developer, an employee, and/or any other authorized individual.

The client computer 106 can be one or more of: a laptop computer, a desktop computer, a tablet computer, a smart phone, a phablet, and any other computing device. The client computer 106 can be operated by another authorized user, such as a merchant, a retailer, a bank employee, and/or any other authorized individual.

Various features of the tree-generating application 108 are described in more detail below by diagrams 700-2300. The communication system 110 can be one or more of: a local area network, a wide area network, internet, intranet, Bluetooth network, infrared network, and other communication networks.

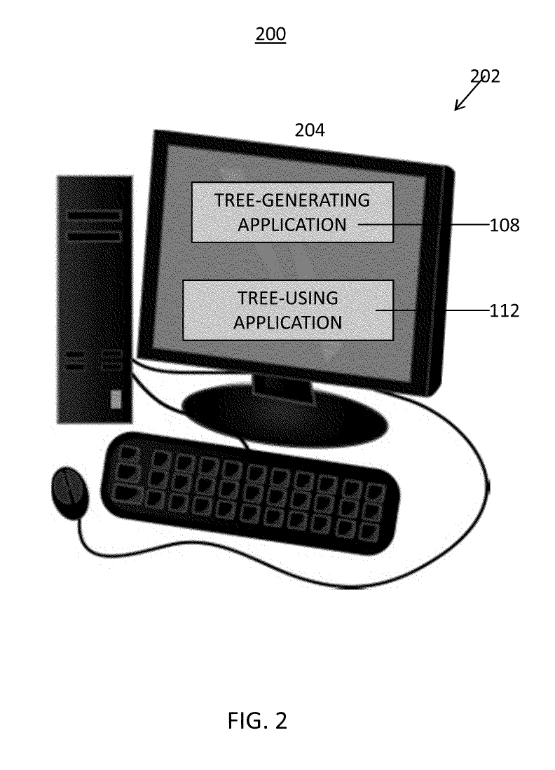

FIG. 2 is a system diagram 200 illustrating an alternate computing system 202 for searching (to determine or obtain), modifying, exporting, importing, and/or using a decision tree. The computing system 202 can include a client computer 204 that can execute both the tree-generating application 108 and a tree-using application 112. The tree-generating application 108 can find a decision tree from a large number of decision trees based on constraints specified by a user of the client computer 204. The tree-generating application 108 can send/export the decision tree to the tree-using application 112. The tree-using application 112 can receive/import the decision tree and use the decision tree to assign optimal treatments (for example, offers) to multiple records (for example, customers).

The client computer 204 can be one or more of: a laptop computer, a desktop computer, a tablet computer, a smart phone, a phablet, and any other computing device. The client computer 204 can be operated by an authorized user, such as one or more of: a system administrator, a developer, an employee, a merchant, a retailer, a bank employee, and any other authorized individual.

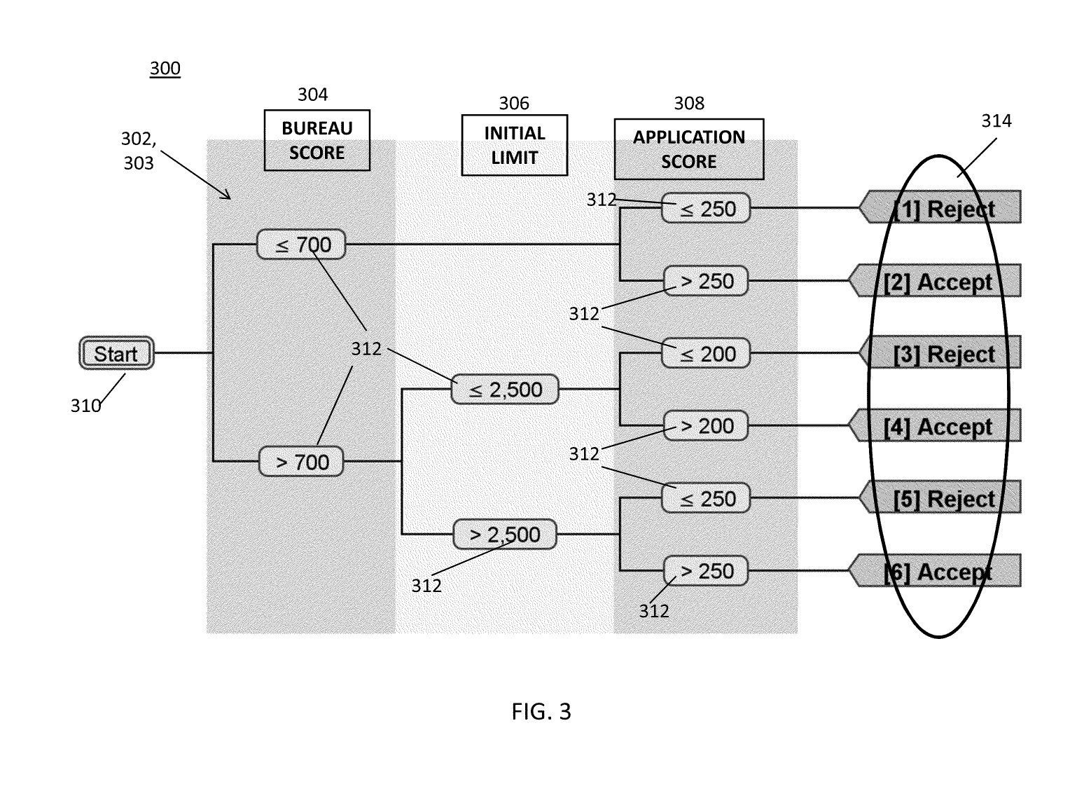

FIG. 3 is a diagram 300 illustrating one example of a decision tree 302. The decision tree 302 can include classification rules that can be used to assign a treatment (for example, whether a loan should be provided—accept or reject) to each customer of a plurality of customers based on one or more attributes, such as constraints associated with credit bureau score 304, an initial limit (for example, initial limit of loan) 306, and an application score (for example, behavior score) 308 of each customer. The decision tree 302 can also be referred to as a strategy tree.

The decision tree 302 can be a flowchart 303 (or a similar structure) representing one or more classification rules. The flowchart 303 can include a start node 310, intermediate nodes 312, and terminal nodes 314. The path from the root node 310 to the terminal nodes 314 can represent the one or more classification rules. Each intermediate node 312 of the flowchart 303 can characterize a test (for example, “Is credit bureau score of a particular individual between 400 and 600?”) on an attribute (for example, “credit bureau score”). Each branch of the flowchart 303 can characterize an outcome (for example, “Yes, credit bureau score is between 400 and 600”) of the test. Each terminal nodes 314 can characterize the treatment (for example, whether a loan should be provided—accept or reject) determined based on outcomes associated with attributes, such as the credit bureau score 304, the initial limit 306, and the application score 308.

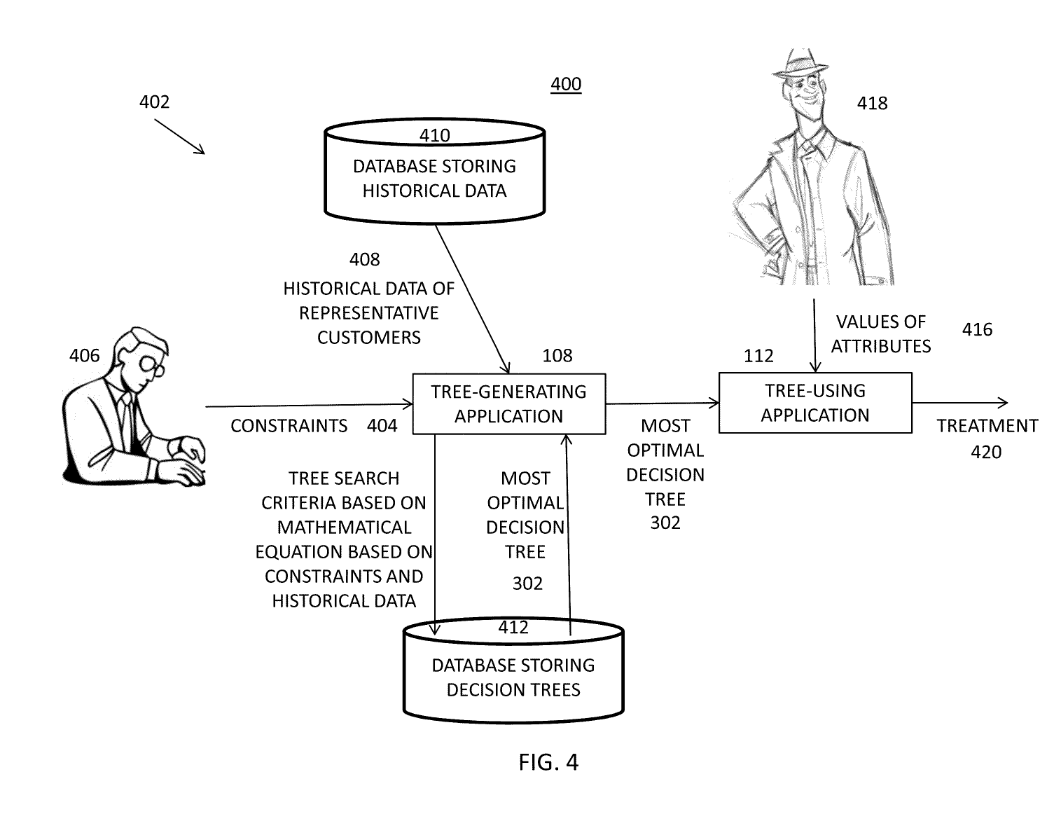

FIG. 4 is a diagram 400 illustrating a system 402 for determining and using a decision tree 302. The system 402 can include a tree-generating application 108 and a tree-using application 112.

The tree-generating application 108 can receive constraints 404 input by a user 406 (for example, an authorized individual, such as a system administrator) of a tree-using application 406, as described in more detail below by diagrams 700, 800, 1000-1200, 1600, 1900, 2000, and 2200. The constraints 404 can include preferences of the user 406 for finding the most optimal decision tree 302 from a large number of decision trees stored in database 412, such as one or more of: specification of nodes and associated ranges, assumptions for the most optimal decision tree 302, predictions to be embedded into the most optimal decision tree 304, granularity constraints for the most optima decision tree 304, eligibility constraints for the most optimal decision tree 304, consistency constraints for the most optimal decision tree 304, and other constraints, as described below in more detail by diagrams 700, 900, and 1000.

The tree-generating application 108 can generate a mathematical equation based on the constraints. In one example, the mathematical equation can be represented as: Maximize the total profit P by summing profits generated from each customer while being subject to restraints including: (1) the total budget, which is sum of budgets spent on each customer, remains within a specified limit (for example, a predetermined fixed limit), (2) each customer must receive an accept or a reject treatment for which all eligibility conditions evaluate to true, (3) if values of two customers are similar (that is, the values of decision keys are closer than the granularity specified for those decision keys), distinctions between customers is not more granular than specified, (4) the pattern of acceptance and rejection across customers is consistent with initial limit, in that if a customer is accepted, any customer with a lower initial limit, and all other decision keys being similar, must also be accepted. Other examples of mathematical equation are possible for other situations.

The tree-generating application 108 can receive historical data 408 of representative customers from a database 410 storing this historical data. The historical data 408 can include values of attributes (for example, credit bureau score 304, initial limit 306, application score 308, and/or any other attributes) of representative customers and treatments offered to those representative customers. The tree-generating application 108 can then search a database 412 storing a large number of decision trees (for example, hundreds or thousands of decision trees) for a most optimal decision tree 302 based on the mathematical equation and the historical data of representative customers. More particularly, the tree-generating application 108 can execute a simplex method of linear programming, which includes a pairwise comparison of each pair of decision trees within the stored decision trees, to search for the most optimal decision tree 302. The obtaining of the most optimal decision tree 302 by the searching process can also be referred to as the generation of the most optimal decision tree 302. The tree-generating application 108 can then send this most optimal decision tree 302 to the tree-using application 112.

The tree-using application 112 can receive the most optimal decision tree 302 from the tree-generating application 108. The tree-using application 112 can receive values 416 of attributes (for example, credit bureau score 304, initial limit 306, application score 308, and/or any other attributes) of a customer 418 (for example, a loan seeking individual, a customer of a retailer, a customer of a bank, and/or the like) from a user of the tree-using application 112. The tree-using application 112 can apply the values 416 of attributes on the most optimal decision tree 302 to determine a specific terminal node 314 (of the most optimal decision tree 302) that is specific to the values 416. This specific terminal node indicates the treatment 420 recommended for the customer 418. The tree-using application 112 can output (for example, display) the treatment 420 recommended for the customer 418. In some implementations, the tree-using application 112 can further assign this treatment 420 to the customer 418.

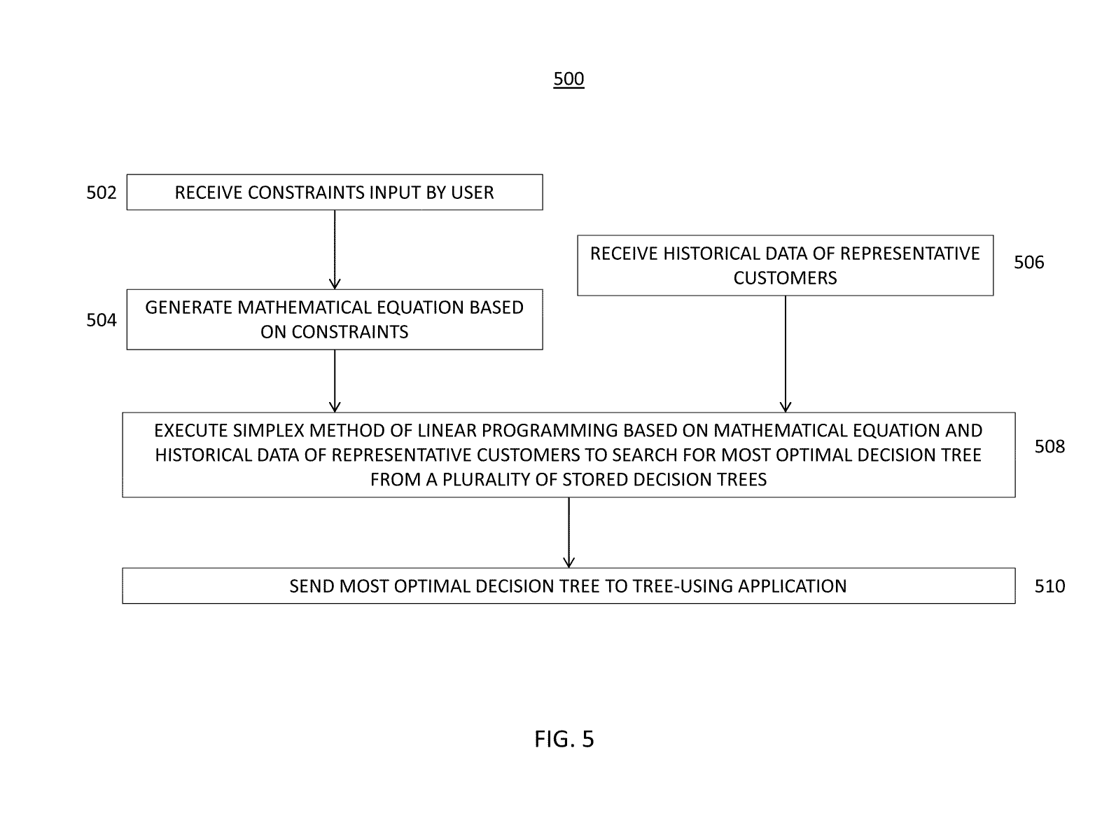

FIG. 5 is a flow diagram 500 illustrating determining of a decision tree 302 by a tree-generating application 108 and the sending of this decision tree 302 to a tree-using application 112. The tree-generating application 108 can receive, at 502, constraints 404 input by a user 406 (for example, an authorized individual, such as a system administrator) of a tree-using application 406, as described in more detail below by diagrams 700, 800, 1000-1200, 1600, 1900, 2000, and 2200. The constraints 404 can include preferences of the user 406 for the most optimal decision tree 302 that is to be searched from a large number of decision trees stored in the database 412, such as one or more of: specification of nodes and associated ranges, assumptions for the most optimal decision tree 302, predictions to be embedded into the most optimal decision tree 304, granularity constraints for the most optimal decision tree 304, eligibility constraints for the most optimal decision tree 304, consistency constraints for the most optimal decision tree 304, and other constraints, as described below in more detail by diagrams 700, 900, and 1000. The tree-generating application 108 can generate, at 504, a mathematical equation based on the constraints. The tree-generating application 108 can receive, at 506, historical data 408 of representative customers from a database 410 storing this historical data. The historical data 408 can include values of attributes (for example, credit bureau score 304, initial limit 306, application score 308, and/or any other attributes) of representative customers and treatments offered to those representative customers. The tree-generating application 108 can then execute, at 508, a simplex method including a pairwise comparison of each pair of a large number of decision trees stored in a database 412 to search for a most optimal decision tree 302 based on the mathematical equation and the historical data of representative customers. The tree-generating application 108 can then send, at 510, this most optimal decision tree 302 to the tree-using application 112.

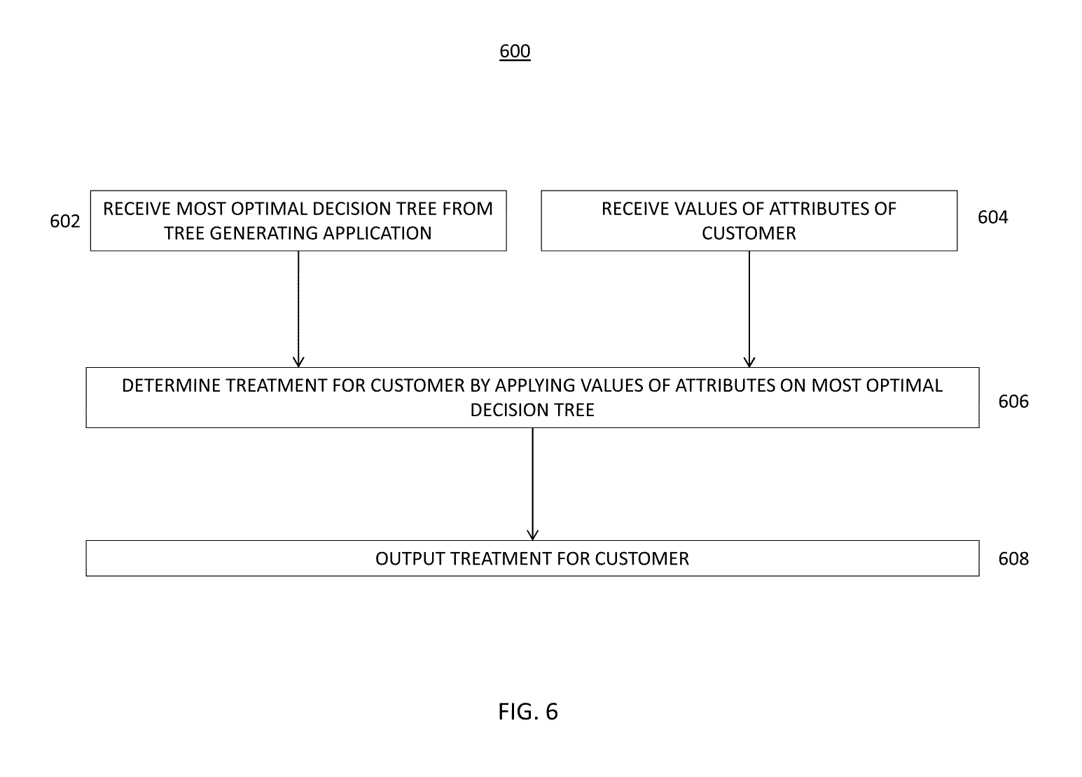

FIG. 6 is a flow diagram 600 illustrating use of a decision tree 302 by a tree-using application 112 to determine a treatment 420 recommended for a customer 418, such as a loan seeking individual, a customer of a retailer, a customer of a bank, and/or the like. The tree-using application 112 can receive, at 602, the most optimal decision tree 302 from the tree-generating application 108. The tree-using application 112 can receive, at 604, values 416 of attributes (for example, credit bureau score 304, initial limit 306, application score 308, and/or any other attributes) of a customer 418 from a user of the tree-using application 112. The tree-using application 112 can apply the values 416 of attributes on the most optimal decision tree 302 to determine, at 606, a specific terminal node 314 (of the most optimal decision tree 302) that is specific to the values 416. This specific terminal node indicates the treatment 420 recommended for the customer 418. The tree-using application 112 can output (for example, display), at 608, the treatment 420 recommended for the customer 418. In some implementations, the tree-using application 112 can further assign this treatment 420 to the customer 418.

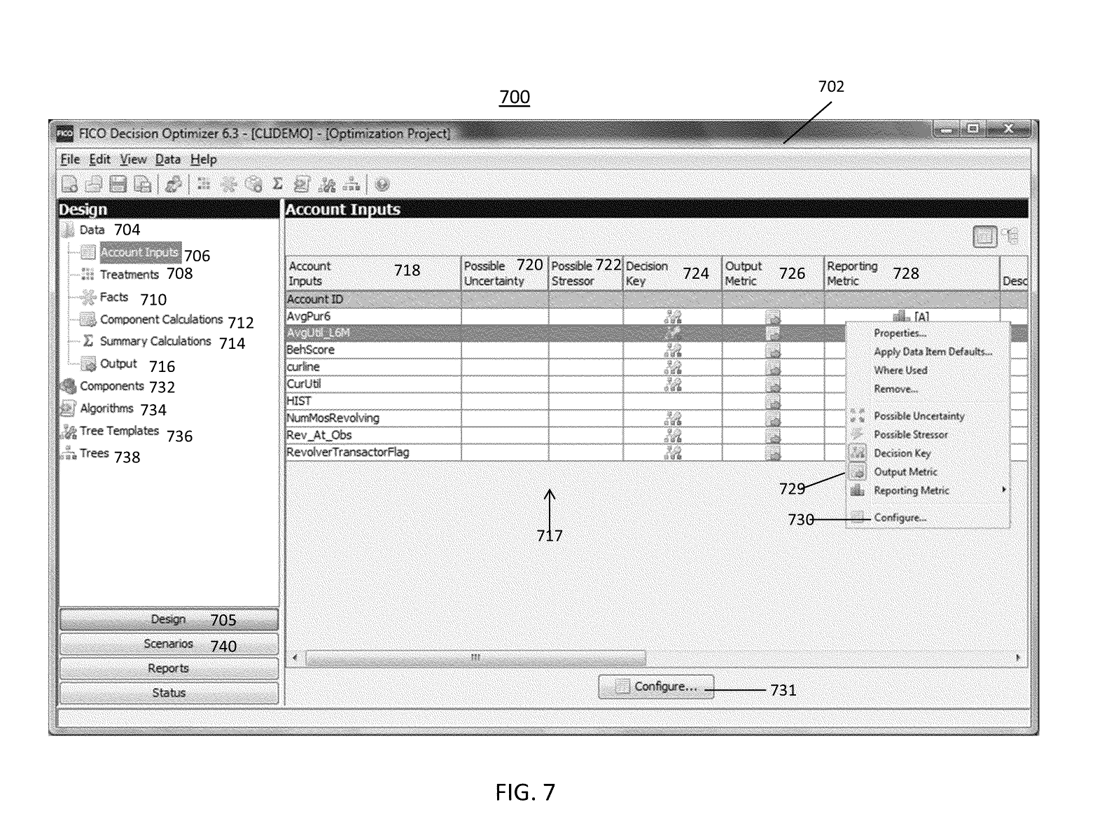

FIG. 7 is a diagram 700 illustrating a graphical user interface 702 executed by the tree-generating application 108 to receive data 704 associated with a design 705 of a decision tree 302 that is to be searched from a large number of decision trees stored in the database 412. The tree-generating application 108 can receive data 704 of representative customers from the database 410, and can receive preferences associated with the data 704 from a user 406 of the tree-generating application 108. The data 704 of representative customers can include account inputs 706, treatments 708 assigned to representative customers, facts 710, component calculations 712, summary calculations 714, and an output 716. The account inputs 706 can include preferences of user 406 associated with historical data 408. The facts 710 can include assumptions for finding a most optimal decision tree 302. The component calculations 712 can include predictions for consumer behavior of a specific representative customer as required for finding a most optimal decision tree 302, such as likelihood a customer will accept offer, likelihood a customer will pay back a loan, how much money a merchant will make if their customer accepts an offered treatment, and/or the like. The summary calculations 714 can include predictions for all the representative customers taken together. The output 716 can include a file including data that the user 406 can troubleshoot to correct errors while finding the decision tree 302.

When the user 406 clicks account inputs 706, the graphical user interface 702 can display area 717 showing account inputs 718. The account inputs 718 can be attributes of representative customers, such as one or more of: average purchase made by each representative customer in past 6 months, average utilization by each representative customer, behavior score of each representative customer, credit bureau score, application score, and/or other attributes. For simplicity, diagram 700 shows attributes for one representative customer only. However, the graphical user interface 702 can include attributes for each representative customer. The user 406 can specify the following for each account input 718: whether it is a possible uncertainty 720, whether it is a possible stressor 722, whether it is a decision key 724, whether it is an output metric 726, whether it is a reporting metric 728, and any other criteria. The decision key 724 can be used to determine nodes and associated values of attributes in the most decision tree 302 that is to be determined by the search process.

When the user 406 right-clicks at the area 717, the graphical user interface 702 can display a pop-up window 729. The pop-up window 729 can include a configure button 730, which, when selected by the user 406, allows the user 406 to configure data (for example, modify decision keys) associated with the account inputs 718. The graphical user interface 702 can further include a configure button 731, which can be alternately selected by the user 406 to configure the account inputs 718.

Further, the graphical user interface 702 can include buttons for components 732, algorithms 734, tree templates 736, and trees 738. The user 406 can click any of these buttons to provide associated specifications. When the user 406 clicks the button components 732, the graphical user interface 702 can display elements associated with component calculations 712. When the user 406 clicks on the button tree templates 736, the graphical user interface 702 allows the user 406 to specify constraints, such as granularity, eligibility, and consistency for decision tree 302 that is to be determined by the search process. When the user 406 clicks on the button trees 738, the graphical user interface 702 displays a list of one or more decision trees that the user 406 has either found previously using the tree-generation application 108 or imported into the tree-generation application 108.

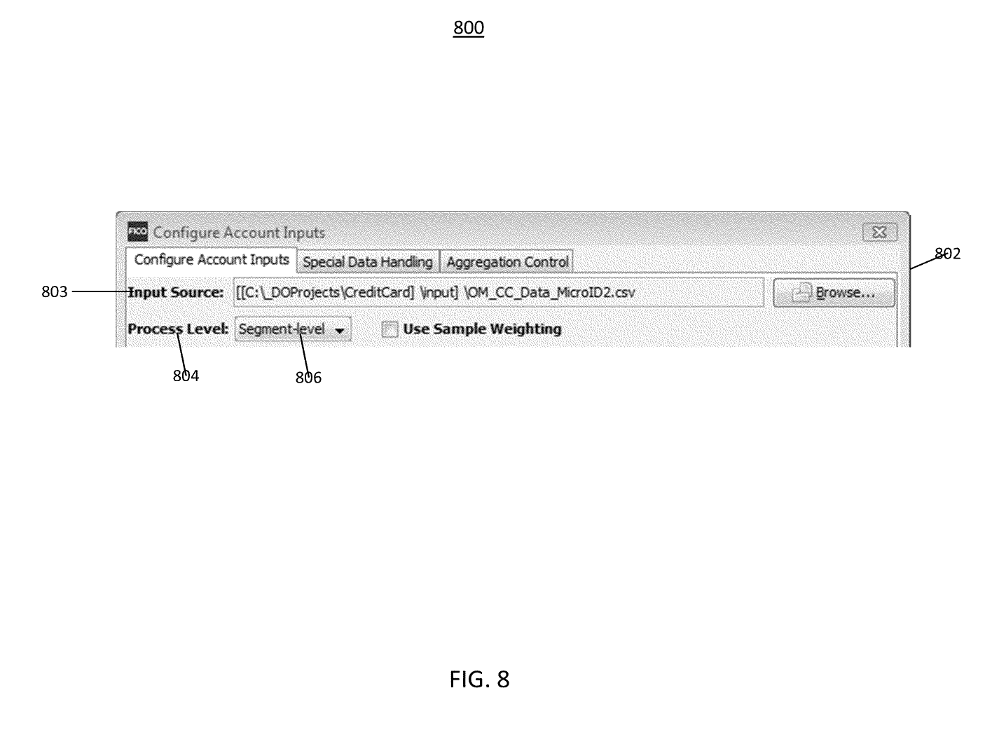

FIG. 8 is a diagram 800 illustrating a portion of a graphical user interface 802 that allows a user 406 to configure account inputs, handle special data, and perform aggregation control. The graphical user interface 802 can be displayed when the user 406 selects the configure button 730 or 731. The tree-generating application 108 can execute the graphical user interface 802. When the user 406 clicks on the configure inputs button, the graphical user interface 802 can allow the process level 804 associated with the account inputs 806 to be specified as segment level or account level, and for either level, whether to use sample weighting. When the account inputs 806 are specified to be segment level, an optimizer, which searches for the most optimal tree, can perform the search based on a segment selected by a user 406 from multiple segments created based on attributes, such as income, credit bureau score, application score, sport played by the customer, and other criteria. In one example, the customers within each segment may have a similar purchase pattern. In another example, the customers within each segment may have a similar behavioral pattern. The optimizer can consider all customers within any particular segment as the same for the purposes of optimization. In other words, the optimizer may not distinguish between different customers within a single segment.

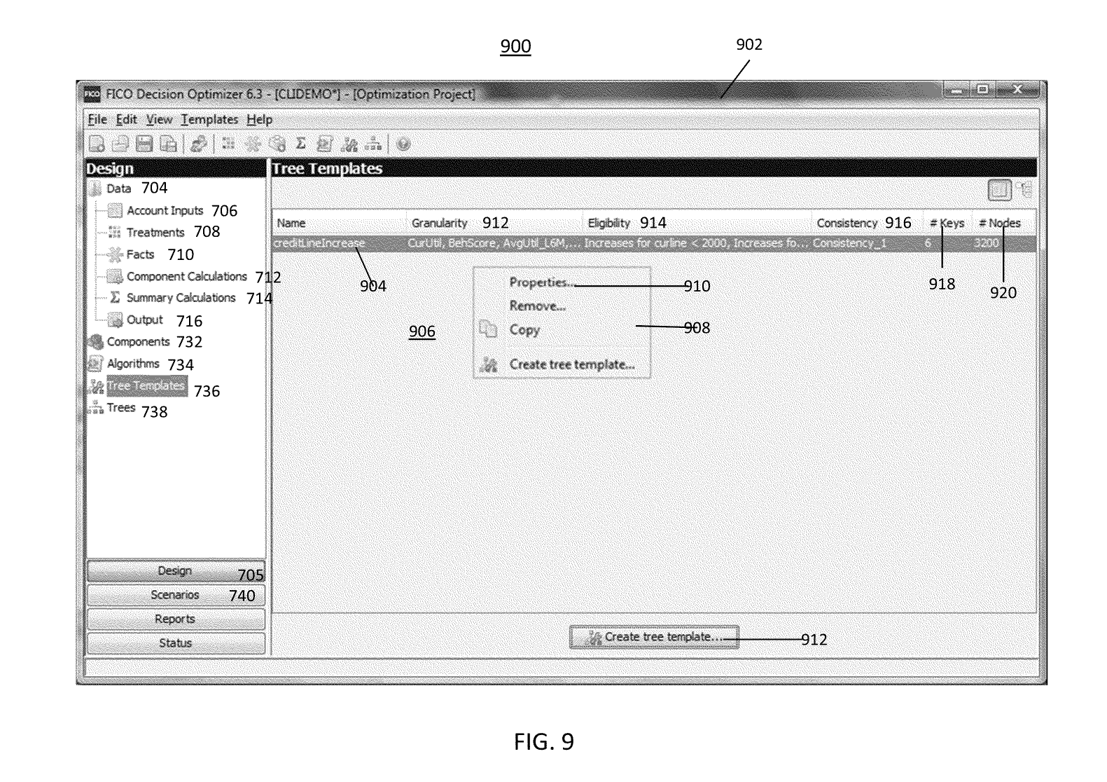

FIG. 9 is a diagram 900 illustrating a graphical user interface 902 that allows the user 406 to specify granularity constraints 912, eligibility constraints 914, consistency constraints 916, number of decision keys 918, and number of nodes 920 for the decision tree 302 that is to be determined by the search process. The tree-generating application 108 can execute the graphical user interface 902. When a user 406 selects the tree templates button 736, the graphical user interface 902 can display (more specifically, a read only display) a name or identifier 904, granularity constraints 912, eligibility constraints 914, consistency constraints 916, number of decision keys 918, and number of nodes 920 for the decision tree 302 that is to be determined by the search process.

The granularity constraints 912 can define the set of allowable decision keys and for each, the set of allowable binnings or split thresholds to use in creating the decision tree 302. The eligibility constraints 914 can define the set of allowable treatments for a record based on the value of its decision keys. A treatment can be assigned to an end segment of the decision tree 302 only if it is eligible to be assigned to each of the records that the decision tree 302 classifies into that end segment. The consistency constraints 916 can define desired patterns in the assignment of treatments across the segments induced by the granularity constraints. In one example, a consistency constraint can relate one real-valued variable A to a second real-valued variable B, over a given scope S, saying that all other decision keys being equal, A must increase (or decrease) in value monotonically (or stay the same) with increasing values of B. The graphical user interface 902 can require the user 406 to specify four things: the numeric variable A (typically a ranking of the treatments), the numeric variable B (typically a numeric decision key), the Boolean scope expression S (typically defined over the decision keys of the decision tree 302), and either increase/decrease. The decision keys and nodes can characterize the size of the decision tree 302.

Numerical optimization techniques can be used for automatically finding a most optimal decision tree to meet all granularity, eligibility and consistency constraints in a decision tree, as well as to achieve desired tradeoffs among numerical performance metrics. The most optimal decision tree can be found by either (a) automatically creating the spilt structure of the decision tree based on the granularity constraints, or (b) modifying the treatments assigned in an existing decision tree (that is, the base tree). Both optimization algorithms can include approaches to formulate the optimization problem into a form that optimization libraries (for example, FICO Xpress library) can solve efficiently. The determining of the most optimal decision tree 302 can involve specifying, formulating and solving instances in programming classes of mixed integer programming (MIP).

The graphical user interface 902 can include area 906. When the user 406 right clicks in the area 906, the graphical user interface 902 can show a pop-up window 908. The pop-up window 908 can include a properties button 910. When the user selects the properties button 910, the tree-generating application 108 can open a template editor that can allow the user to modify the constraints for the decision tree 302 that is to be determined by the search process. The graphical user interface 902 can further include a create tree template button 912. When the user clicks the create tree template button 912, the tree-generating application 108 can allow the user to generate a new decision tree template.

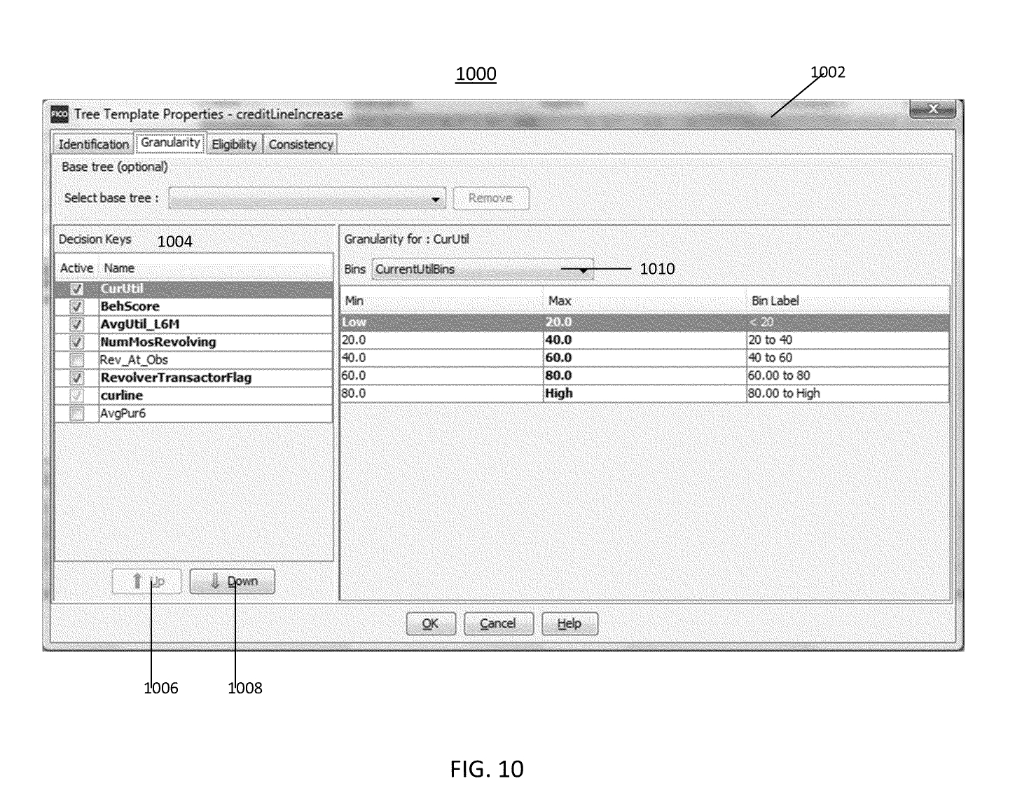

FIG. 10 is a diagram 1000 illustrating a graphical user interface 1002 executed by the tree-generating application 108 to display and specify granularity constraints of the decision tree 302 that is to be determined by the search process. When the user 406 does not select the base tree criterion, as shown in diagram 1000, the graphical user interface 1002 allows the user 406 to specify granularity constraints, eligibility constraints, and consistency constraints. When a user 406 selects the base tree criterion, as described by diagram 1100 discussed below, this selection indicates to the optimizer that an existing decision tree 302 is to be used in optimization algorithm, and in this case, an existing decision tree is used, the graphical user interface 1102 (described below) does not allow the user 406 to specify granularity constraints, eligibility constraints, and consistency constraints.

The tree-generating application 108 can execute the graphical user interface 1002 after the user 406 clicks the properties button 910. The graphical user interface 1002 can include decision keys 1004, and can allow the user 406 to activate one or more of the decision keys 1004. The graphical user interface 1002 can further allow the user 406 to modify order of decision keys by using buttons 1006 and 1008 when a new decision tree 302 is being created using these constraints. Further, as shown at 1010, the graphical user interface 1002 can allow the user to select from all binning schemes defined in the graphical user interface 2200 (described below) to specify splits for the selected decision key.

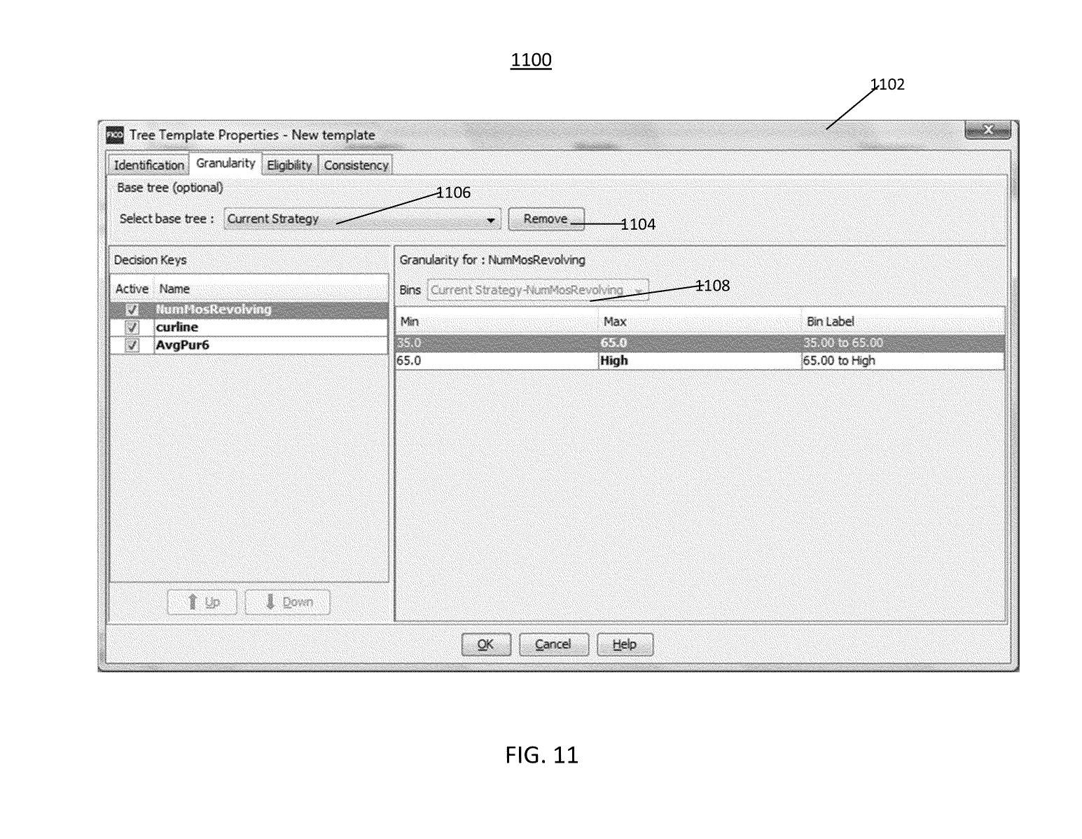

FIG. 11 is a diagram 1100 illustrating a graphical user interface 1102 executed by the tree-generating application 108 to display and specify granularity constraints associated with the decision tree template when a base tree is selected. The graphical user interface 1102 can include a remove button 1104 that can be used by the user to remove the base tree from the decision tree template. As noted by 1106 and 1108, the base tree can characterize read-only granularity constraints. Bins can be automatically defined based on splits found in the decision tree.

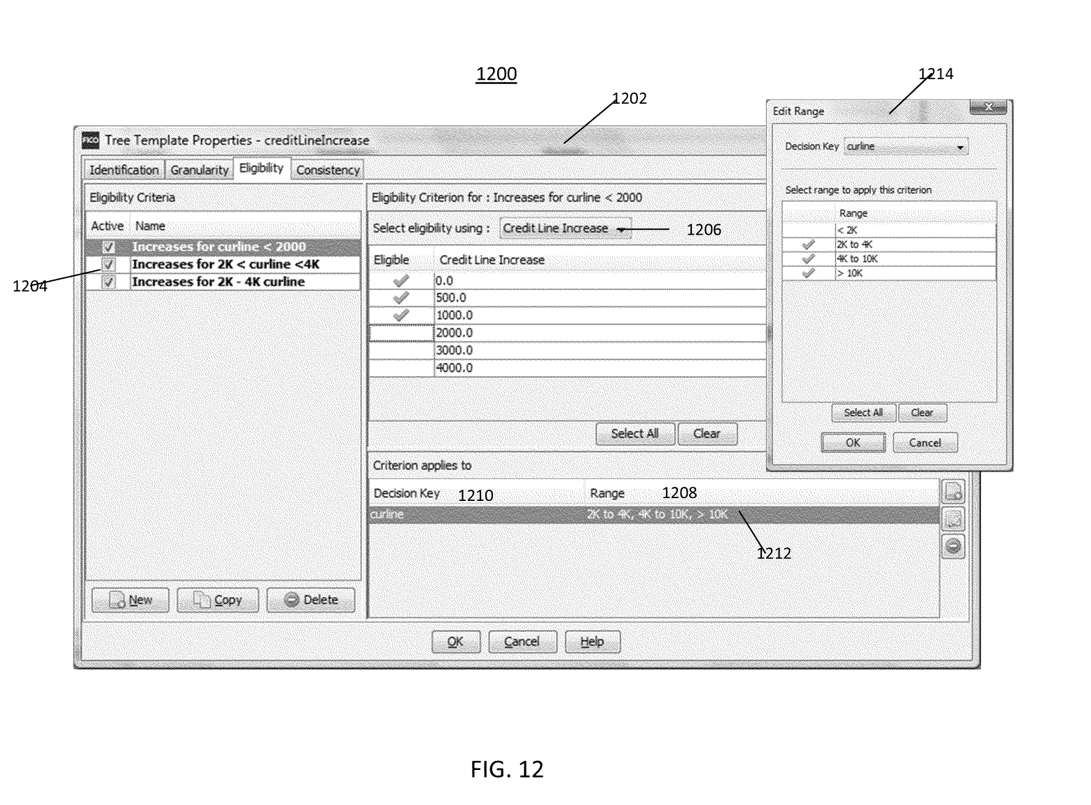

FIG. 12 is a diagram 1200 illustrating a graphical user interface 1202 executed by the tree-generating application 108 to display and specify eligibility constraints for the decision tree 302 that is to be determined by the search process. The graphical user interface 1202 can include eligibility constraints 1204. The graphical user interface 1202 can allow the user to specify as many eligibility constraints as required or desired. In the shown example, the graphical user interface 1202 allows a user 406 to select which credit line increases can be eligible for a customer. As shown at 1206, the graphical user interface 1202 can allow specification of eligibility by treatment or action. Further, the graphical user interface 1202 can allow the user 406 to specify scope of one or more eligibility constraints. For example, the user 406 can specify a range 908 associated with each decision key 1210 associated with respective eligibility constraints. When the user 406 clicks on the area 1212, the graphical user interface 1202 can display a pop-up window 1214 that allows the user 406 to modify the range of each decision key.

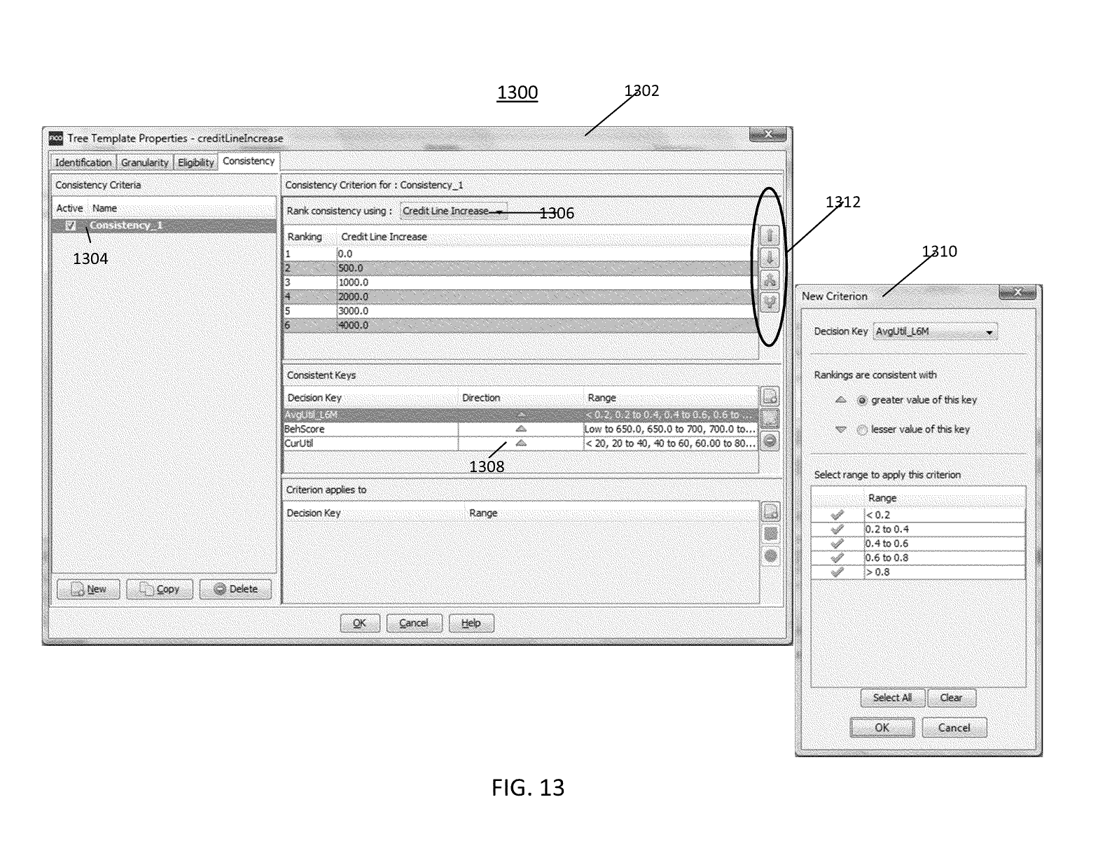

FIG. 13 is a diagram 1300 illustrating a graphical user interface 1302 executed by the tree-generating application 108 to display and specify consistency constraints for the decision tree 302 that is to be determined by searching from a large number of decision trees stored in the database 412. The graphical user interface 1302 can include consistency constraints 1304. The graphical user interface 1302 can allow the user 406 to specify as many consistency constraints as required or desired. As shown at 1306, the graphical user interface 1302 can specify consistency by treatment or action. The graphical user interface 1302 can allow the user 406 to specify, at 1308 and at associated pop-up window 1310, specific decision key values that move monotonically (either up or down) with the action, as well as the range of values of the decision key over which this monotonic relationship is to be applied. In the shown example, the user 406 has specified that higher the current average utilization of available credit, the higher should be the credit line increase. The ordering of the actions or treatments up or down in the ranking can be specified by using buttons 1312. Equivalencies in ranking among two or more actions or treatments also can be specified by using buttons 1312.

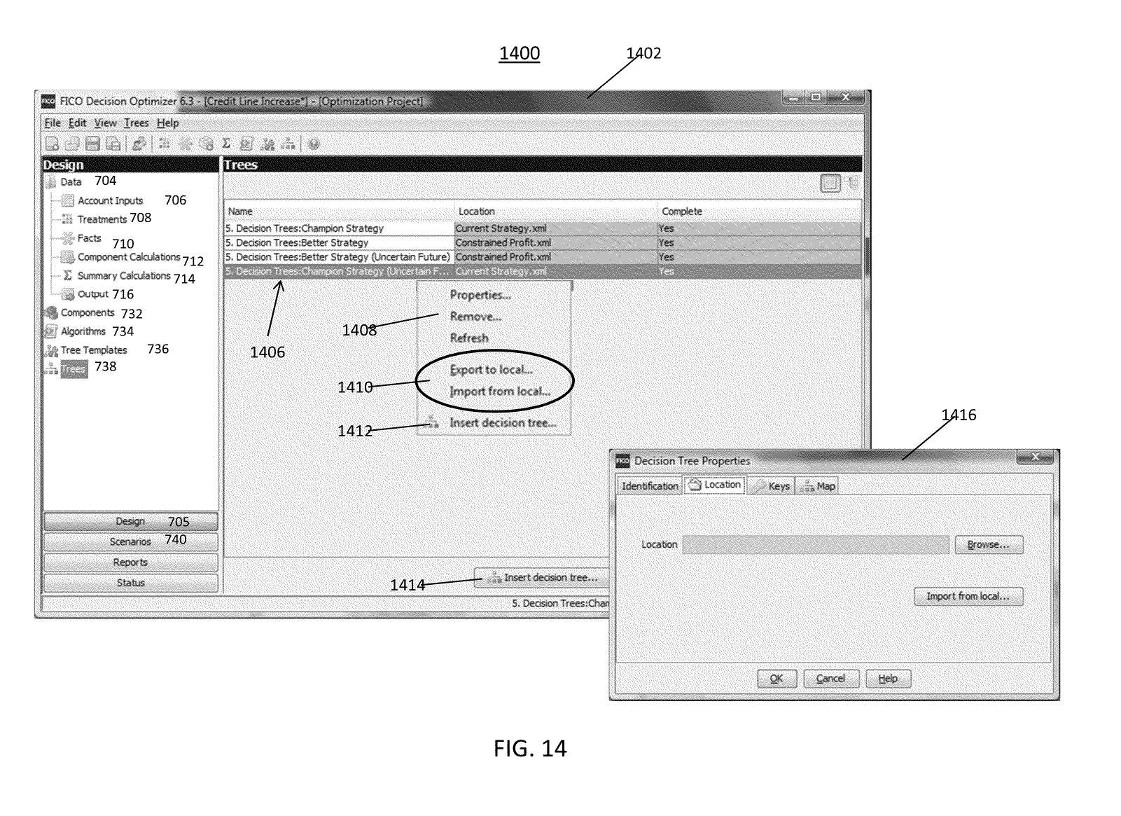

FIG. 14 is a diagram 1400 illustrating a graphical user interface 1402 that displays the list of decision trees 302 that have already been created by the tree-generating application 108. The tree-generating application 108 can execute the graphical user interface 1402. When a user selects the trees button 738, the graphical user interface 1402 can display data 1404 associated with existing decision trees 302. The decision trees 302 can be exported from the tree-generating application 108 or imported to the tree-generating application 108. In one implementation, the export function can be used to export a selected decision tree from the server computer 104 to the client computer 106, and the import function can be used to import a selected decision tree from the client computer 106 to the server computer 104. The display area 1406 of the decision trees can be compatible with the display area of decision trees in older versions and future versions of the tree-generating application 108. When the user 406 right-clicks on a particular decision tree 302 in the display area 1406, the graphical user interface 1402 can display a pop-up window 1408 presenting options 1410 to export the selected decision tree 302 to a local client computer and import the selected decision tree 302 from a local client computer. The graphical user interface 1402 allows the user 406 to click one of option 1412 and button 1414 to insert a new decision tree 302 into a project. When the user 406 clicks one of option 1412 and button 1414, the graphical user interface 1402 can display a pop-up window 1416 that allows the user 406 to obtain the project by browsing a server location or importing the project from a local client.

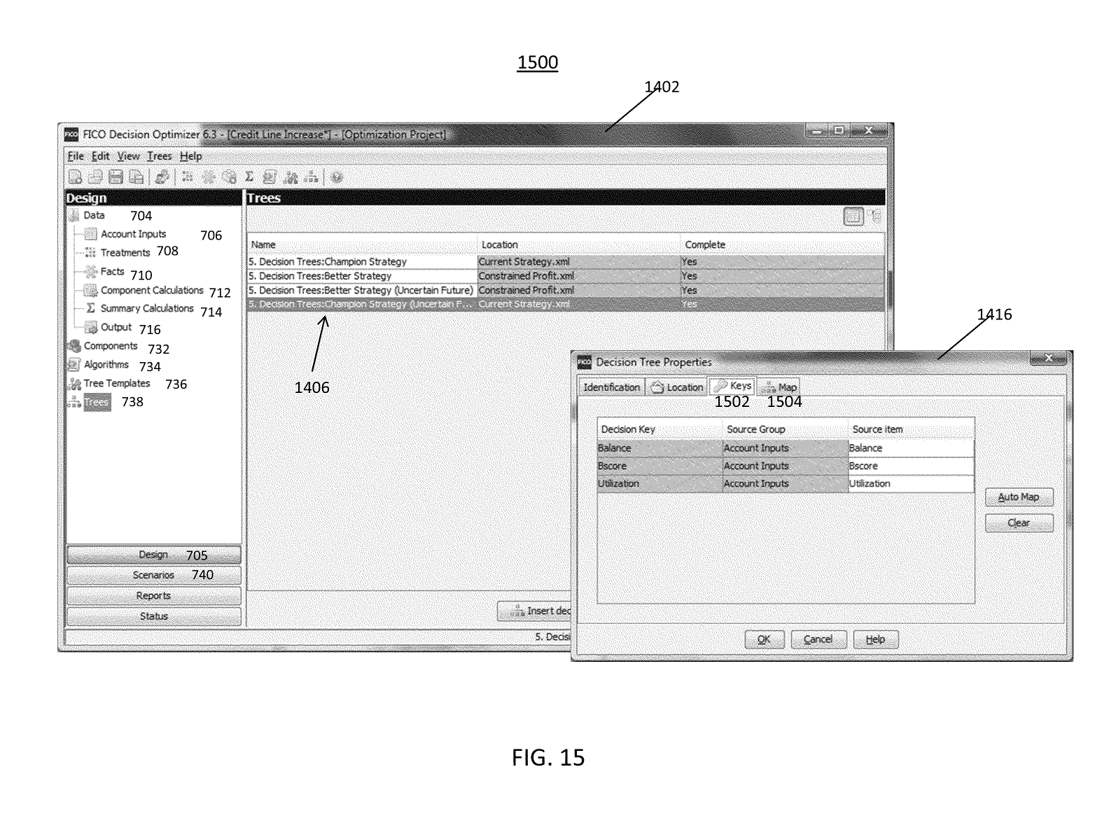

FIG. 15 is a diagram 1500 illustrating a graphical user interface 1402 that displays pop-up window 1416 to allow the user 406 to view or modify properties of an existing decision tree 302 shown in the display area 1406. The graphical user interface 1402 can display the pop-up window 1416 when the user clicks on the “Properties” tab in the pop-up window 1408. The pop-up window 1416 can include a keys button 1502, which, when clicked, displays decision keys specified for the decision tree 302 and corresponding attributes or account inputs. This display is a read-only display. The pop-up window 1416 can include a map button 1504 that the user 406 can click to view a read-only map of decision keys of each decision tree with respective treatments.

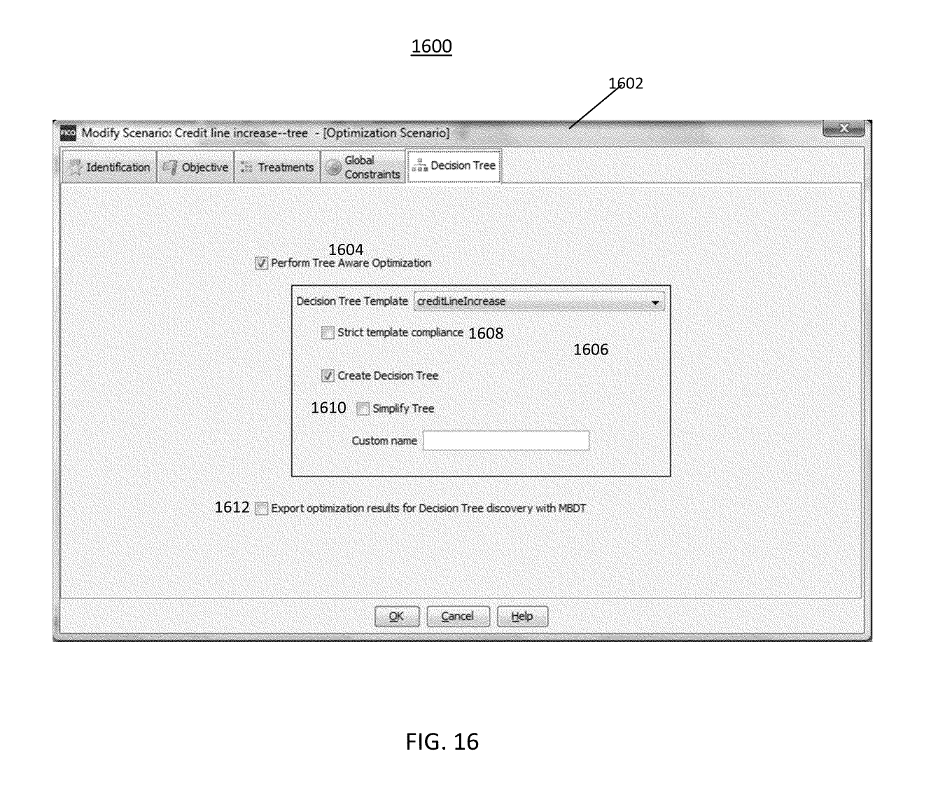

FIG. 16 is a diagram 1600 illustrating a graphical user interface 1602 illustrating design scenarios. A design scenario can also be referred to as a what-if scenario. In other words, a design scenario can include one or more what-if considerations. The graphical user interface 1602 is displayed by the tree-generating application 108 when the user 406 clicks the design button 405.

The graphical user interface 1602 allows a user 406 to configure a design scenario for a decision tree 302 that is to be searched from a large number of decision trees stored in the database 412. The graphical user interface 1602 displays option 1604 and display area 1606 only when there are already existing decision trees in the display area 1406. When an existing decision tree is selected, the final decision tree that is to be searched has a structure similar to the selected decision tree and complies with the constraints specified by the user 406. When the user 406 checks the strict tree compliance box 1608, the optimizer searches for a tree from the large number of decision trees in database 412 that strictly complies with the specified constraints. If there is no decision tree within the database 412 that strictly complies with the constraints, the optimizer generates an error indicating that there is no tree available for the specific constraints. When the user 406 does not check the strict tree compliance box 1608 and when the database 412 does not include a decision tree specific to the required constraints, the optimizer searches for a tree that has constraints closest to the specified constraints. When the user selects the simplify decision tree box 1610, the optimizer can prune one or more unnecessary or redundant branches of the most optimal decision tree 302 that is to be determined by searching a large number of decision trees stored in the database 412. The graphical user interface 1602 can provide an option 1612 that the user 406 can select to export results of the optimization for finding a most optimal decision tree 302 to an external decision tree editing software application.

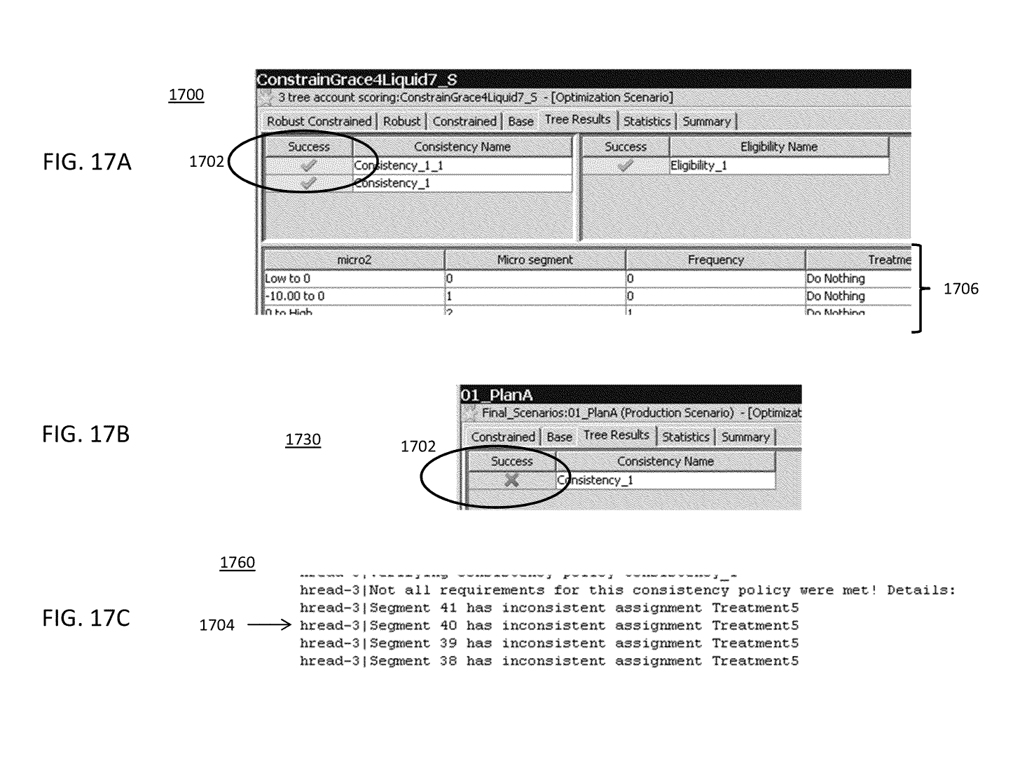

FIGS. 17A, 17B, and 17C are diagrams 1700, 1730, and 1760, respectively, illustrating read-only summary results of optimization performed to determine a most optimal decision tree 302 that is to be searched from a large number of decision trees stored in the database 412. The tree-generating application 108 can display these summary results. The portion 1702 includes a check mark next to a constraint when the constraint has been met by (that is, compliant with) the searched most optimal decision tree 302, as shown in diagram 1700. The portion 1702 includes a cross mark (that is, “x”) next to a constraint when the constraint has not been met by the already searched most optimal decision tree 302, as shown in diagram 1730. When some constraints is not met by the searched most optimal decision tree 302, the tree-generating application 108 displays a log 1704 (a portion of which is illustrated for simplicity) showing a detail list of the segments that did not meet those constraints, as shown by diagram 1760. The summary results can include more results 1706, which are described in more detail below by diagram 1800.

The diagram 1700 further shows four different types of optimizations that are possible—robust constrained optimization, robust optimization, constrained optimization, and base optimization. A user 406 can select the type of optimization by clicking on a corresponding tab shown in diagram 1700.

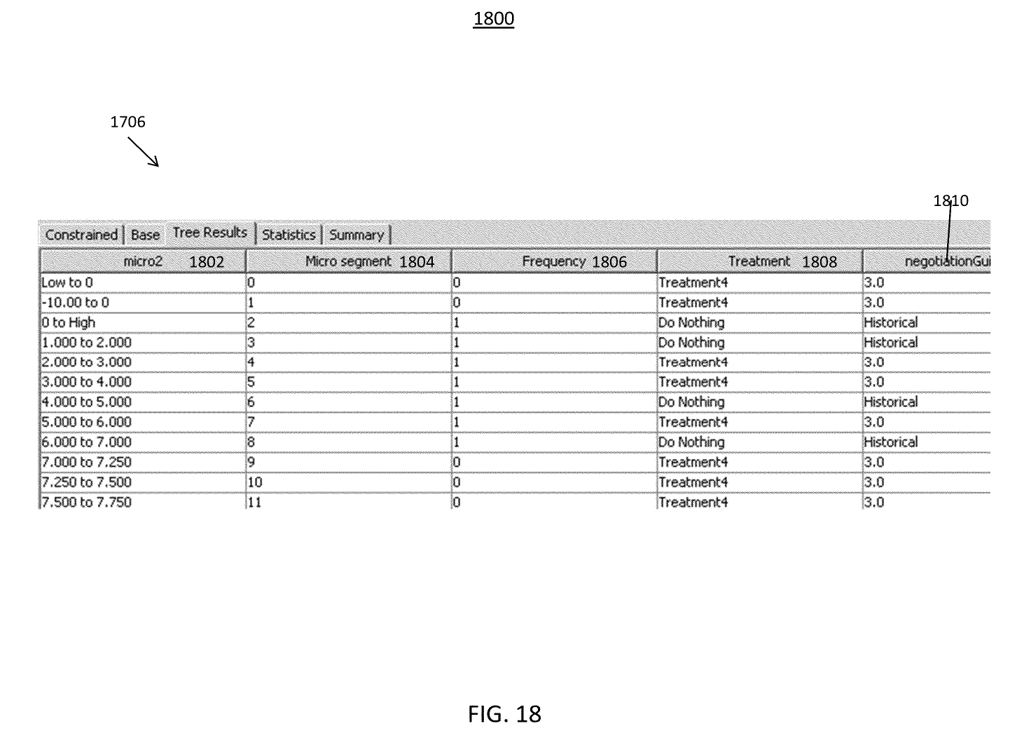

FIG. 18 is a diagram 1800 illustrating another example of summary results 1706 of optimization performed to find a decision tree 302 from a large number of decision trees stored in the database 412. The summary results 1706 can include decision keys and splits 1802, associated leaf identifiers 1804, frequency 1806 of account inputs for this node, treatments 1808 assigned for the terminal nodes, and action values 1810.

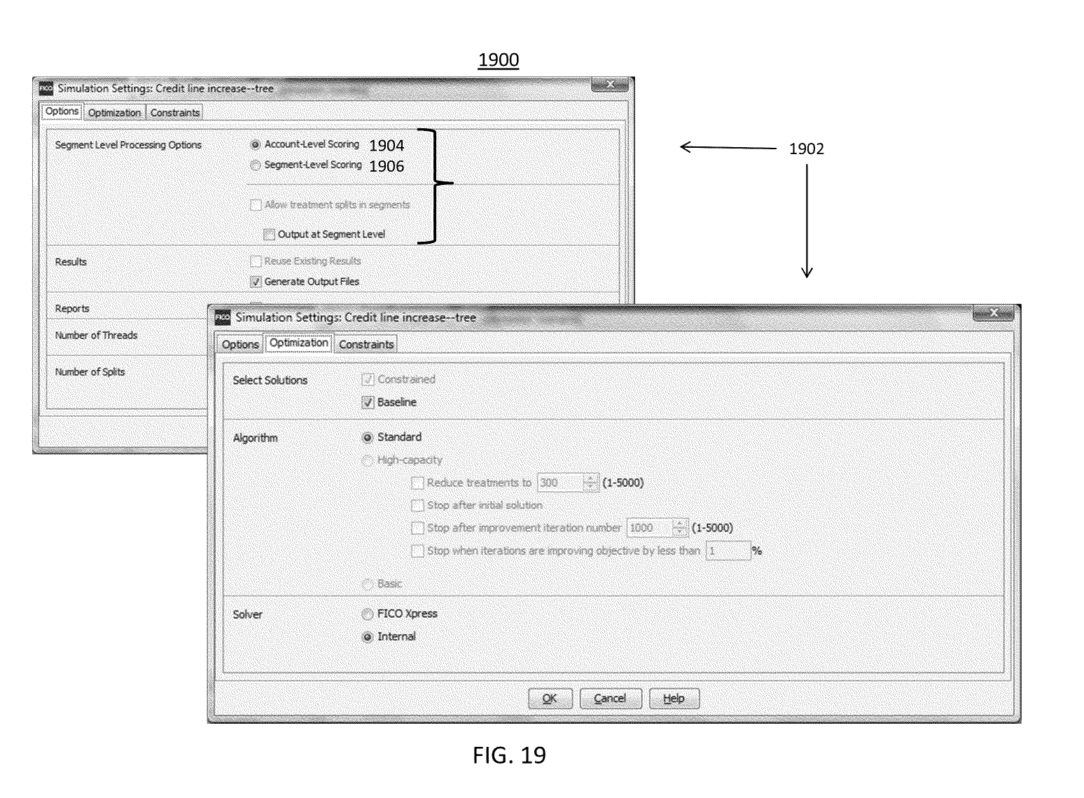

FIG. 19 is a diagram 1900 illustrating advanced simulation settings 1902 for searching a most optimal decision tree 302 from a large number of decision trees stored in the database 412. When the user 406 clicks the scenarios tab 740, and then selects a particular scenario, the tree-generating application 108 can display the advance simulation settings 1902. The account level scoring 1904 can search for the most optimal decision tree 302 based on the entire historical data 408 of all the representative customers. The segment level scoring 1906 can search for the most optimal decision tree 302 based on a segment of the historical data 408. Thus, while the segment level scoring 1906 may be relatively less accurate than the account level scoring 1904, it can be faster than the account level scoring 1904.

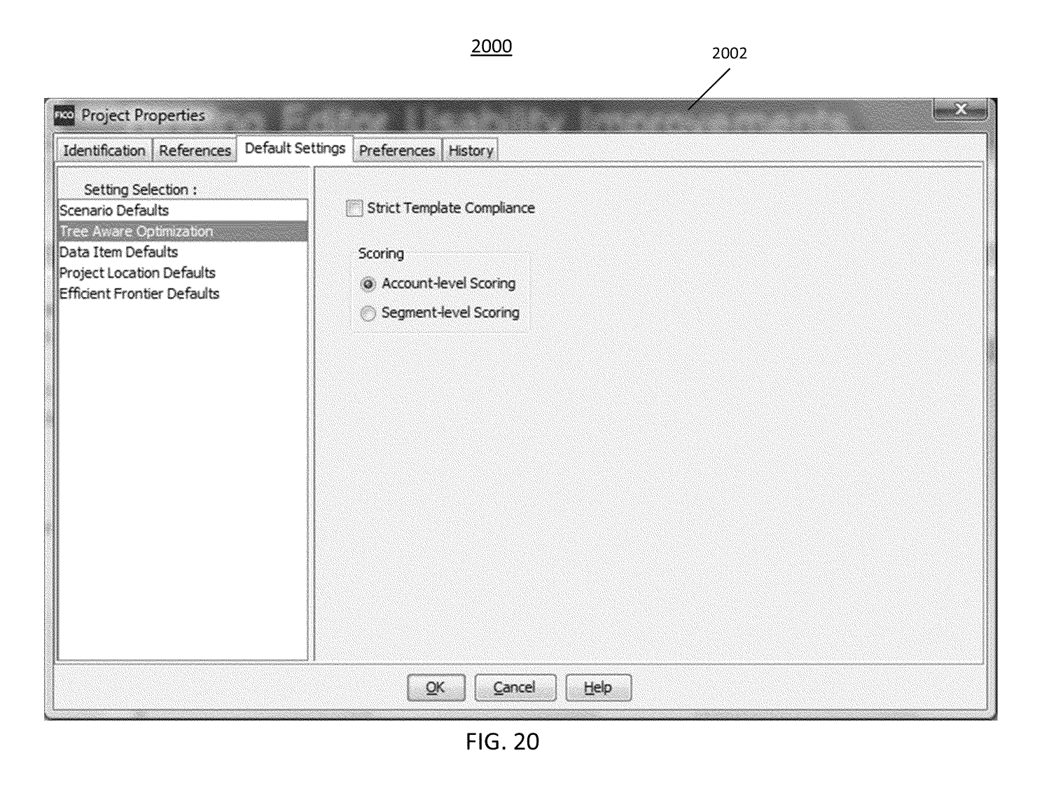

FIG. 20 is a diagram 2000 illustrating a graphical user interface 2002 displaying properties of the project being performed to search for a most optimal decision tree 302 from a large number of decision trees stored in the database 412. The tree-generating application 108 executes the graphical user interface 2002 to display these properties when the user clicks on a file menu at the top of the graphical user interface 702, and then clicks on a project properties tab. The graphical user interface 2002 can allow the user 406 to specify default settings for every scenario.

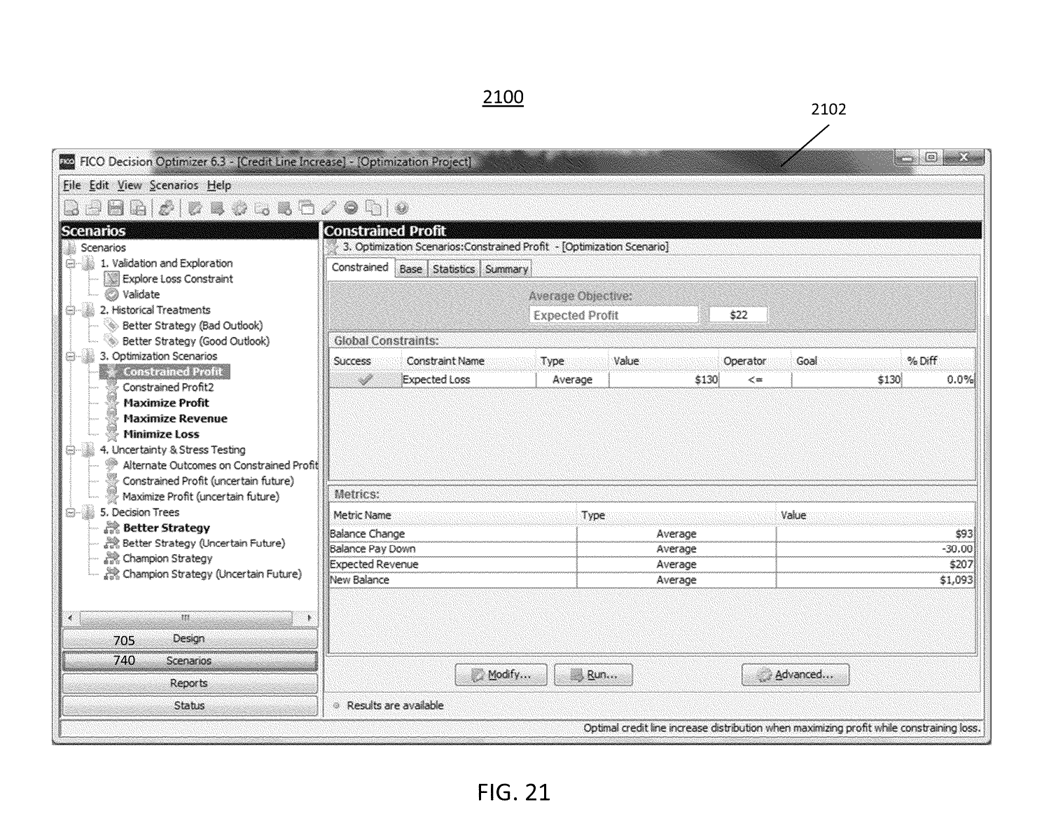

FIG. 21 is a diagram 2100 illustrating a graphical user interface 2102 that allows a user 406 to compare performance of a most optimal decision tree 302 searched from a large number of decision trees stored in the database 412 with existing decision trees shown in the display area 1406. The tree-generating application 2102 can execute the graphical user interface 2102.

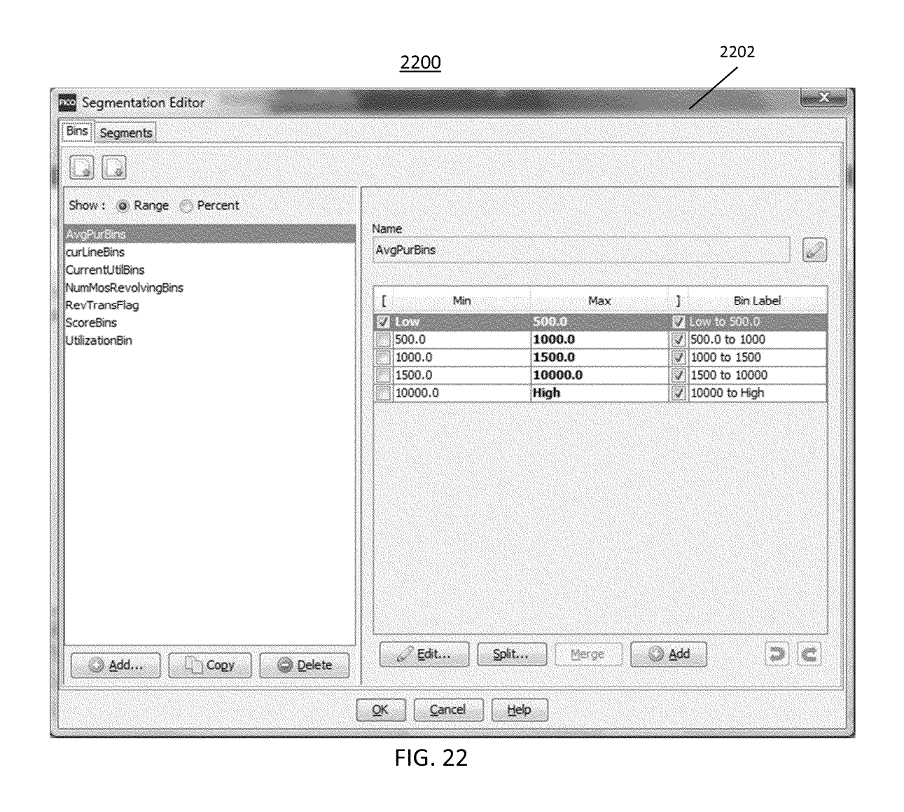

FIG. 22 is a diagram 2200 illustrating a segmentation editor 2202 that allows a user 406 to specify data associated with bins and segments that can be used during the search of the decision tree 302 from a large number of decision trees stored in the database 412. The tree-generating application 2102 can execute the segmentation editor 2202.

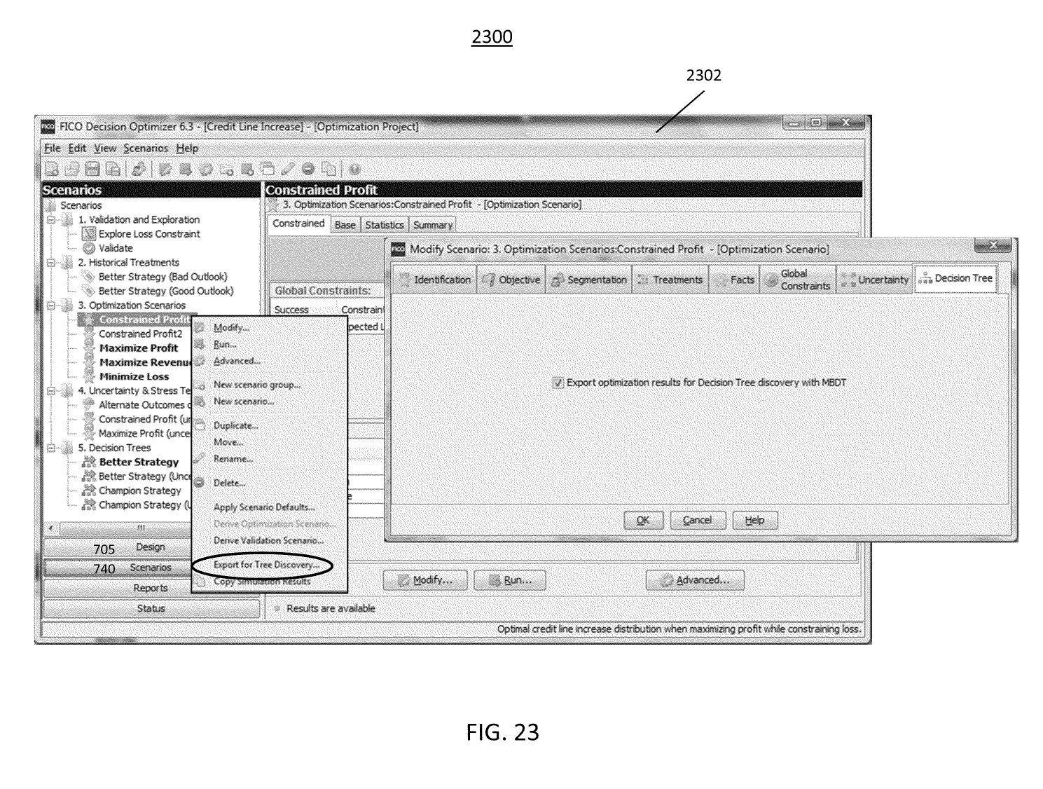

FIG. 23 is a diagram 2300 illustrating a graphical user interface 2302 executed by the tree-generating application 108 to export optimization results to an external decision tree editing application, such as a Model Builder for Decision Trees (MBDT). The tree-generating application 2102 can execute the graphical user interface 2302.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other embodiments may be within the scope of the following claims.

What is claimed is:

1. A method comprising:
receiving, by a tree-generating application executed by at least one data processor, one or more constraints characterizing specifications for a decision tree;
generating, by the tree-generating application, a mathematical equation based on the one or more constraints;
receiving, by the tree-generating application and from a first database connected to the at least one processor, historical data characterizing treatments provided to a plurality of representative customers having corresponding attributes;
executing, by the tree-generating application, a simplex method of linear programming using the mathematical equation and the historical data to search for the decision tree from a plurality of decision trees stored in a second database connected to the at least one processor; and
sending, by the tree-generating application, the decision tree to a tree-using application executed by a second data processor, the tree-using application using the decision tree to determine a treatment for a customer.

2. The method of claim 1, wherein the first data processor is same as the second data processor.

3. The method of claim 1, wherein the first data processor is different from the second data processor.

4. The method of claim 1, wherein:
the tree-using application is operated by an authorized user at a retail entity; and
the customer is a shopper at the retailer entity.

5. The method of claim 4, wherein the treatment of the customer specifies an offer provided to the shopper by the retail entity.

6. The method of claim 5, wherein the offer is a discount offer on a product provided by the retail entity.

7. The method of claim 1, wherein:
the tree-using application is operated by an authorized user at a financial institution; and
the customer is an individual seeking a loan from the financial institution.

8. The method of claim 7, wherein the treatment of the customer specifies whether the financial institution should approve the loan to the individual.

9. The method of claim 1, wherein the attributes of a representative customer of the plurality of representative customers include a credit bureau score of the representative customer, an initial credit limit of the representative customer, and an application score of the representative customer.

10. The method of claim 1, wherein the decision tree comprises a flow chart comprising a start node, a plurality of intermediate nodes, and a plurality of terminal nodes, the flow chart representing a plurality of classification rules between the start node and the terminal node that are based on the attributes of the plurality of representative customers, the plurality of classification rules being used to map each representative customer with a corresponding terminal node of the plurality of terminal nodes, each terminal node characterizing a corresponding treatment.

11. The method of claim 1, wherein the specifications comprise granularity constraints, eligibility constraints, and consistency constraints.

12. The method of claim 11, wherein the granularity constraints specify decision keys and split thresholds for nodes of the decision tree.

13. The method of claim 12, wherein the eligibility constraints specify eligible treatments for a representative customer based on the decision keys.

14. The method of claim 13, wherein the consistency constraints specify patterns for assignment of treatments to terminal nodes of the decision tree.

15. The method of claim 1, wherein the tree-generating application prunes the decision tree by removing redundant nodes and branches of the decision tree when the tree-generating application receives a user preference for the decision tree to be simplified.

16. A method comprising:
receiving, by at least one data processor, one or more constraints characterizing specifications for a decision tree;
generating, by the at least one data processor, a mathematical equation based on the one or more constraints;
receiving, by the at least one data processor and from a first database connected to the at least one processor, historical data characterizing treatments provided to a plurality of representative customers having corresponding attributes;
executing, by the at least one data processor, a simplex method of linear programming using the mathematical equation and the historical data to search for the decision tree from a plurality of decision trees stored in a second database connected to the at least one processor, the decision tree being used to determine a treatment for a customer.

17. The method of claim 16, wherein the decision tree is used by a second data processor to determine the treatment.

18. The method of claim 17, wherein the second data processor is same as the first data processor.

19. The method of claim 17, wherein the first data processor is separate from the second data processor, the first data processor being connected to the second data processor via a communication network.

20. A system comprising:
a first computer executing a tree-generating application, the tree-generating application receiving one or more constraints characterizing specifications for a decision tree, the tree-generating application generating a mathematical equation based on the one or more constraints, the tree-generating application receiving historical data characterizing treatments provided to a plurality of representative customers having corresponding attributes from a first database connected to the first computer, the tree-generating application executing a simplex method of linear programming using the mathematical equation and the historical data to search for the decision tree from a plurality of decision trees stored in a second database connected to the at least one processor; and
a second computer executing a tree-using application, the tree-using application receiving the decision tree, the tree-using application using the decision tree to determine a treatment for a customer.

21. The system of claim 20, wherein the first computer is same as the second computer.

22. The system of claim 20, wherein the first computer is separate from the second computer, the first computer being connected to the second computer via a communication network.
